(19) United States
(12) Patent Application Publication
(10) Pub. No.: US 2016/0358515 A1
(43) Pub. Date: Dec. 8, 2016

(54) ANCHOR OF A GREETING CARD

(71) Applicant: RICHARD CHRISTIANSEN, PROVO, UT (US)

(72) Inventor: RICHARD CHRISTIANSEN, PROVO, UT (US)

(21) Appl. No.: 14/732,788

(22) Filed: Jun. 8, 2015

(51) Int. Cl. G09F 1/06; B42D 15/04

(52) U.S. Cl. CPC G09F 1/06; B42D 15/04

(57) ABSTRACT

The present invention is related to the anchor to support the pop-up element of the foldable pop-up greeting card. The anchor is pierced through the surface of pop-up element to provide a good grip and required strength to erect the pop-up-element.

### BACKGROUND

The present invention related to the field of pop-up greeting cards. More particularly, the invention is directed to the anchor to support the pop-up element of the greeting cards.

Pop-up greeting cards are often presented on anniversaries, birthdays, graduations, holidays and other personal or holiday occasions or in friendship to each other. Pop-up greeting cards are well-known in the related art, in a variety of designs. Pop-up cards commonly include text, drawings, and pictures on the card itself, as well as pop-up figures. Usually, base of pop-up element is glued to the inner surface of the greeting card in order to support the pop-up element. The base of the pop-up element is glued in such a way that the portion of the base is folded when the greeting card is in the folded state and it gets unfolded when the greeting card is in an unfolded state. However, the regular folding and unfolding of the greeting card affects the base of the pop-up element and hence increases the chances of getting unglued from the inner surface of the greeting card which is undesirable.

In an alternative way, threads are commonly used to attach the pop-up element, where one end of thread is attached to the inner surface of greeting card and second end is attached to the multiple components of the pop-up element. However, the regular folding and unfolding of the greeting card the tension in the thread loses and hence can affect the unfolded position of the pop-up element which is highly undesirable.

In another alternative way, pop-up elements are designed manufactured as a part of the inner surface of the greeting card so that no attaching component is required to support the pop-up element. The base of the pop-up element is integrally attached to the inner surface and hence making it a part of the greeting card itself. However, regular folding and unfolding of greeting card increases the stress on the base of the pop-up element and hence becomes the reason of tear off which is undesirable.

The present invention proposes an anchor to support the pop-up element which overcomes the problems of the prior art.

It is an object of the present invention to provide a robust and durable support to the pop-up element of the greeting card

These and other objects and advantages of the invention will become more apparent from the following detailed description.

### BRIEF DESCRIPTION OF THE DRAWINGS

Other objects and features will become apparent from the following detailed description taken in combination with the accompanying drawings. However, the drawings are provided for purpose of illustration only, and are not intended as a definition of the limits of the invention.

FIG. 1 is an isometric view of the foldable greeting card 101 in a folded position in accordance with the present invention.

FIG. 2 is an isometric view of the foldable greeting card 101 in an opening position in accordance with the present invention.

FIG. 3 is a side view of the foldable greeting card 101 where anchor 300 is shown in a foldable position in accordance with the present invention.

FIG. 4 is an isometric view of the foldable greeting card 101 in a complete unfolded position in accordance with the present invention.

FIG. 5 is an isometric view of multiple anchors attached with the pop-up element 201 of the foldable greeting card 101 in accordance with the present invention.

FIG. 6 is an isometric view of the anchor 300 in accordance with the present invention.

### DETAILED DESCRIPTION OF THE PRESENT INVENTION

The present invention will now be described more fully hereinafter with reference to the accompanying drawings, in which the preferred embodiment of the invention is shown. This invention may, however, be embodied in different forms and should not be construed as limited to the embodiment set forth herein. Rather, the illustrative embodiment is provided so that this disclosure will be thorough and complete, and will full convey the scope of the invention to those skilled in the art. Like numbers refer to like elements throughout.

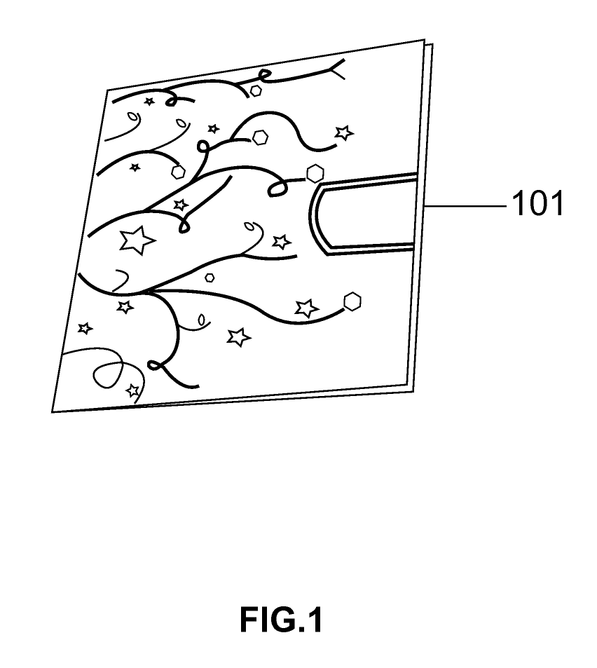

FIG. 1 illustrates an isometric view of the foldable greeting card 101 in a folded position. The outer surface of the foldable greeting card comprises a decorative design and enables the user to write a customized message on it as well.

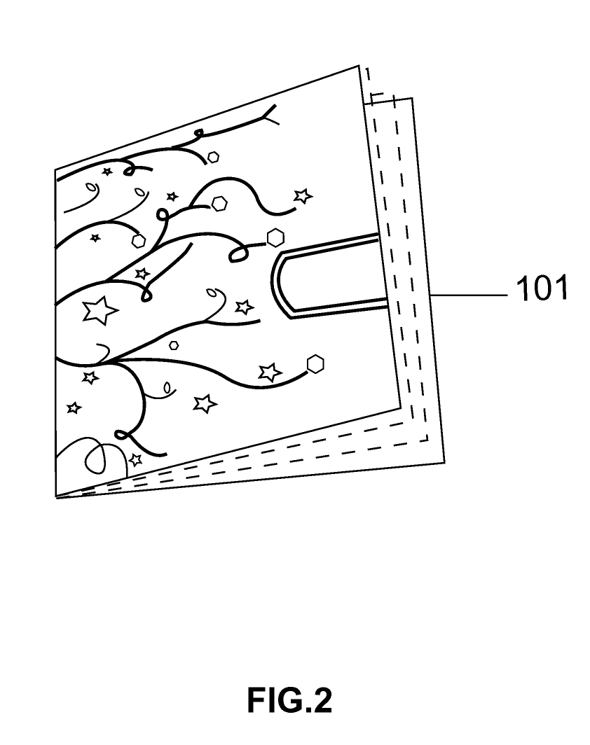

FIG. 2 illustrates an unfolding of the foldable greeting card 101 where the anchor 300 is seen to be in a folding position.

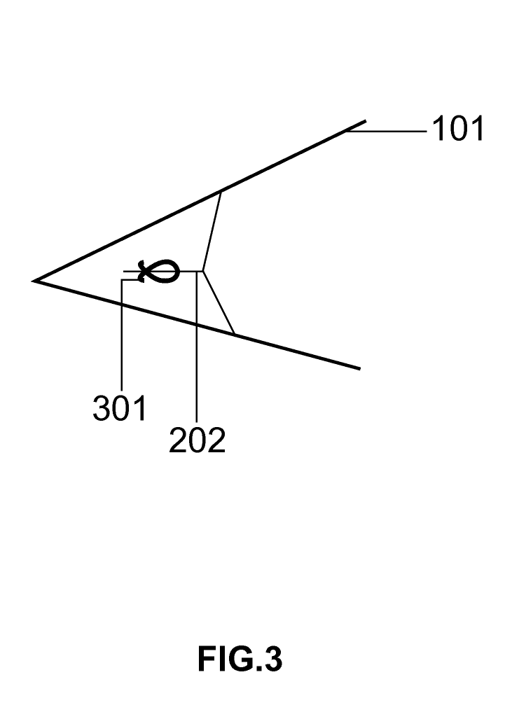

FIG. 3 illustrates a side view of the foldable greeting card 100 in an unfolding state where the anchor 300 is seen to be in a folded position.

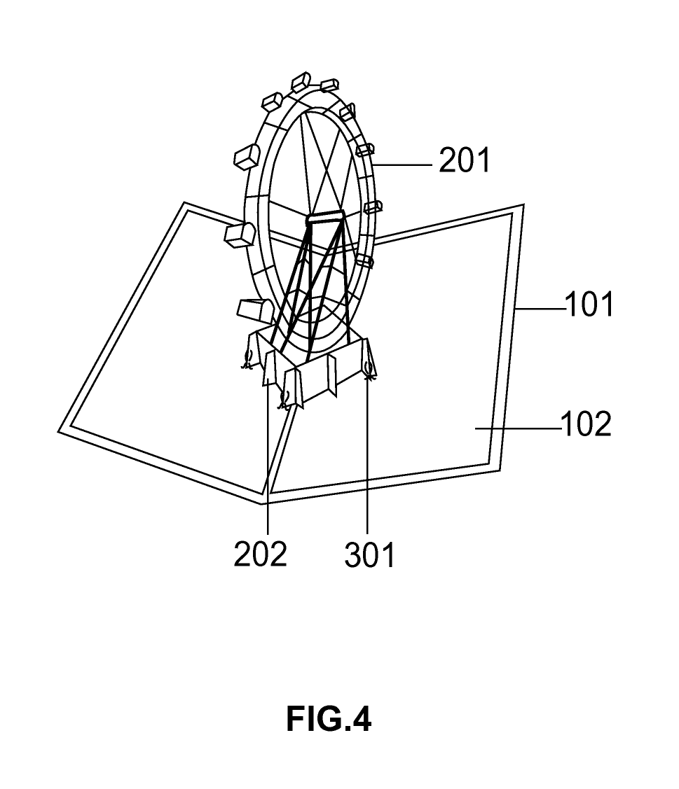

FIG. 4 is a preferred embodiment of the present invention where the FIG. 4 illustrates an unfolded view of the foldable greeting card 101. In the unfolded state of the greeting card 101, the pop-up element 201 is lifted by the anchor 300 thereby erecting the pop-up element 201. The anchor 300 is attached to the pop up element 201 in a way where the anchor body 301 is pierced through the surface 202 of the pop-up element 201 to at least three different locations 203, 204 and 205 making half of the anchor to remain on either side of the surface 202 of the pop-up element 201. First end 302 and second end 303 of the anchor 300 are attached to the inner surface 102 of the foldable pop-up greeting card 101 which give the robust stability to the pop-up element 202. Since, the anchor 300 is pierced through the surface 202 of pop-up element 201 hence it provides good grip and required strength to erect the pop-up-element 201.

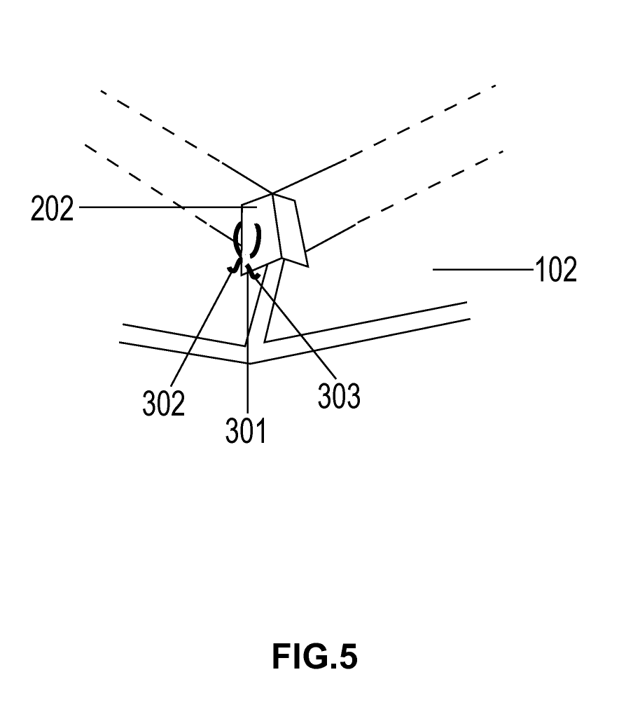

FIG. 5 illustrates a view of how the multiple anchors 301 are attached to the pop-up element 201. Two anchors 301 are attached diagonally opposite to each other in order to provide robust stability to the pop-up element 201 in an unfolded position of the foldable pop-up greeting card 101. The anchor body 301 of each anchor 300 pierces through the surface 202 of the pop-up element 201 at three different locations 203, 204 and 205 and making the first end 302 and second end 303 of the anchor to remain on the opposite side of the surface 202 of the pop-up element 201 wherein the first end 302 and second end 303 are attached to the inner surface 102 of the foldable pop-up greeting card 101.

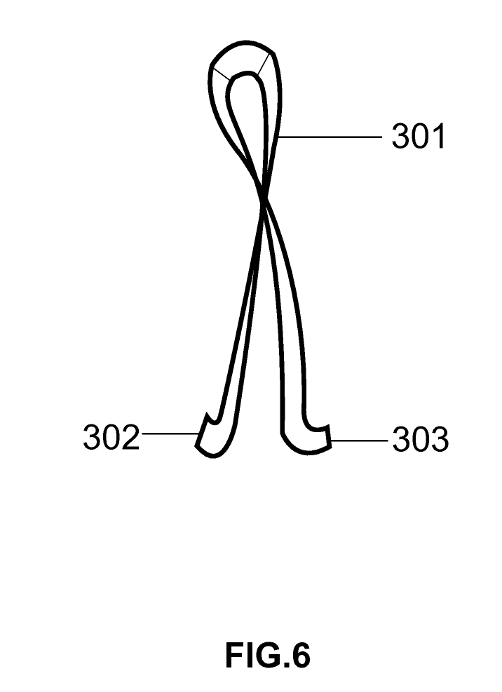

FIG. 6 illustrates a perspective view of the anchor 300. The anchor body 301 is twisted to assist the easy piercing the surface 202 of pop-up element 201.

Various changes can, of course, be made to the preferred embodiment of the present invention without departing from the spirit and scope of the present invention. The present invention, therefore, should not be restricted, except to the following claims and their equivalents.

### SUMMARY

The present invention is related to the anchor to support the pop-up element of the foldable pop-up greeting card. In the unfolded state of the foldable pop-up greeting card, the pop-up element is lifted by the anchor thereby erecting the pop-up element. The anchor is attached to the pop up element in a way where the anchor body is pierced through the surface of the pop-up element making half of the anchor to remain on either side of the surface of the pop-up element. First end and second end of the anchor is then attached to the inner surface of the foldable pop-up greeting card which gives the robust stability to the pop-up element. Since, the anchor is pierced through the surface of pop-up element hence it provides good grip and provides required strength to erect even the big and complex pop-up-element.

I claim:

1. A foldable pop-up greeting card comprising:
a. An outer surface, wherein the outer surface is enabled to provide a suitable space for a user to write a customizable message;
b. An inner surface, wherein at least one pop-up element is attached to the inner surface by at least one anchor wherein the each anchor comprising:
b1. A first end, wherein the first end of the anchor is enabled to connect to the inner surface of the foldable pop-up greeting card at a first location;
b2. A second end, wherein the second end of the anchor is enabled to connect to the inner surface of the foldable pop-up greeting card at a second location;
b3. An anchor body, wherein the anchor body is a part between the first end and the second end of the anchor, wherein the anchor body pierces a surface of the pop-up element to at least three different locations.

2. The foldable pop-up greeting card of claim 1, wherein the first location and the second location are situated opposite to each other at the inner surface.

3. The foldable pop-up greeting card of claim 1, wherein each anchor is located space apart from another anchor.

4. The foldable pop-up greeting card of claim 1, wherein the at least one anchor is located in diagonally opposite direction with respect to another anchor.

5. The foldable pop-up greeting card of claim 1, wherein the at least one anchor is folded when the foldable pop-up greeting card is in a folded state and the at least one anchor is unfolded when the foldable pop-up greeting card is in an unfolded state.

6. The foldable pop-up greeting card of claim 1, wherein the at least one of first end and second end of anchor is located at the center of the inner surface of the foldable pop-up greeting card.

7. The foldable pop-up greeting card of claim 1, wherein the at least one anchor is made of either string or thread or a combination thereof.

8. The foldable pop-up greeting card of claim 1, wherein the pop-up element is a 3-dimensional configuration, wherein the pop-up element is folded when the foldable pop-up greeting card is in the foldable state and the pop-up element is unfolded when the foldable greeting card is in the unfolded state.

9. The foldable pop-up greeting card of claim 1, wherein the first end and second end are attached to the inner surface of the foldable pop-up greeting card by at least one of micro-nail, spring, glue or any combinations thereof.

10. A method of attaching at least one pop-up element of a foldable pop-up greeting card to an inner surface of the foldable pop-up greeting card, the method comprising:
a. Connecting first end of an anchor at a first location at the inner surface of the foldable pop-up greeting card;
b. Piercing a surface of the pop-up element to at least three different locations by an anchor body, wherein the anchor body is a part between first end and second end of the anchor, and
c. Connecting second end of the anchor at a second location on the inner surface of the foldable pop-up greeting card.

11. The method of claim 10, wherein the first location and the second location are situated opposite to each other at the inner surface.

12. The method of claim 10, wherein each anchor is located space apart from another anchor.

13. The method of claim 10, wherein the at least one anchor is located diagonally opposite direction with respect to another anchor.

14. The method of claim 10, wherein the at least one anchor is folded when the foldable pop-up greeting card is in a folded state and the at least one anchor is unfolded when the foldable pop-up greeting card is in an unfolded state.

15. The method of claim 10, wherein the at least one of first end and second end of anchor is located at the center of the inner surface of the foldable pop-up greeting card.

16. The method of claim 10, wherein the at least one anchor is made of either string or thread or a combination thereof.

17. The method of claim 10, wherein the pop-up element is a 3-dimensional configuration, wherein the pop-up element is folded when the foldable pop-up greeting card is in the foldable state and the pop-up element is unfolded when the foldable pop-up greeting card is in the unfolded state.

18. The method of claim 10, wherein the first end and second end is attached to the inner surface of the foldable pop-up greeting card by at least one of micro-nail, spring, glue and any of the combinations thereof.
